(19) United States
(12) Patent Application Publication
(10) Pub. No.: US 2026/0048644 A1
(43) Pub. Date: Feb. 19, 2026

(54) VEHICLE REAR DOOR STRUCTURE

(71) Applicant: NISSAN NORTH AMERICA, INC., Franklin, TN (US)

(72) Inventors: Luke CORDES, Bloomfiled Hills, MI (US); Srikanth Reddy BADDAM, Northville, MI (US); David KOVIE, Livonia, MI (US)

(21) Appl. No.: 18/807,896

(22) Filed: Aug. 16, 2024

(51) Int. Cl. B60J 5/10

(52) U.S. Cl. CPC B60J 5/106

(57) ABSTRACT

A rear panel assembly defines a rear opening and a motor attachment section and includes a door linkage assembly, a rear door and an electric motor. The door linkage assembly is connected to the rear panel assembly adjacent to one side of the rear opening. The door linkage assembly including a pivoting lever with a first end having a bore with an inner splined surface. The rear door attached to the door linkage assembly for movement between an open orientation and a closed orientation. The electric motor includes a mechanical attachment portion and a shaft having outer splines that fit within the bore and engage the inner splined surface. The mechanical attachment portion has a plurality of attachment structures that adjustably align the position and orientation of the shaft relative to the inner splined surface of the bore.

### BACKGROUND

### Technical Field

The present disclosure generally relates to rear door assembly supported by a pivoting bar mechanism powered by an electric motor. More specifically, the present disclosure relates to a rear door that is moved by a bar mechanism in response to operation of an electric motor that is attached to a vehicle body structure and engages a portion of the bar mechanism such that the position and angular orientation of the electric motor relative to an end of the bar mechanism is adjustable to ensure smooth movement of the bar mechanism and rear door.

### Background Information

Rear door assemblies of vehicles such as SUVs (sport utility vehicles) typically pivot rearward and upward. An electric motor typically couples to a portion of the rear door in order to move the rear door between open and closed orientations.

### SUMMARY

One object of the present disclosure is to provide a vehicle body structure that enables accurate positioning of an electric motor thereto to ensure alignment between a shaft of the electric motor and a bar member of a rear door assembly when the electric motor is installed to a vehicle and coupled to the bar member of the rear door assembly.

In view of the state of the known technology, one aspect of the present disclosure is to provide a vehicle rear door structure with a vehicle body structure, a door linkage assembly, a rear door and an electric motor. The vehicle body structure has a rear panel assembly that defines a rear opening and a motor attachment section. The door linkage assembly is connected to the rear panel assembly adjacent to one side of the rear opening. The door linkage assembly includes at least one pivoting lever with a first end having a bore with an inner splined surface. The rear door is attached to the rear panel assembly via the door linkage assembly for movement between an open orientation exposing the rear opening and a closed orientation covering the rear opening. The electric motor has a mechanical attachment portion and a shaft having outer splines dimensioned and shaped to fit within the bore and engage the inner splined surface such that operation of the electric motor moves the rear door between the open orientation and the closed orientation. The mechanical attachment portion has a plurality of attachment structures that adjustably align with the motor attachment section such that the position and orientation of the shaft can be adjusted into alignment with the bore. Once the shaft and the bore are aligned, the electric motor and the motor attachment section are rigidly fixed in position.

### BRIEF DESCRIPTION OF THE DRAWINGS

Referring now to the attached drawings which form a part of this original disclosure:

FIG. 1 is a side view of a rear portion of a vehicle body structure that includes a rear door assembly with a rear door in a closed orientation in which the rear door is generally vertically oriented in accordance with a first embodiment;

FIG. 2 is another side view of the rear portion of the vehicle body structure that includes the rear door assembly with the rear door moved rearward and upward from the closed orientation to a first intermediate orientation in accordance with the first embodiment;

FIG. 3 is another side view of the rear portion of the vehicle body structure with the rear door moved further upward to a second intermediate orientation where the door has undergone angular displacement in accordance with the first embodiment;

FIG. 4 is another side view of the rear portion of the vehicle body structure with the rear door moved further upward and partially over a roof structure of the vehicle body structure to a third intermediate orientation where the door has undergone further angular displacement in accordance with the first embodiment;

FIG. 5 is another side view of the rear portion of the vehicle body structure with the rear door moved further forward over the roof structure of the vehicle body structure to a fully open orientation where the rear door has fully exposed a rear opening of the vehicle body structure in accordance with the first embodiment;

FIG. 6 is a rear view of the vehicle showing the rear door in a closed orientation in accordance with the first embodiment;

FIG. 7 is a rear view of the vehicle showing the rear door in the fully open orientation and further showing first and second hinge assemblies of a four-bar support mechanism in accordance with the first embodiment;

FIG. 8 is perspective view of the first and second hinge assemblies of the four-bar support mechanism and a locking assembly removed from the vehicle in accordance with the first embodiment;

FIG. 9 is a perspective view of a rearward corner of the vehicle body structure showing the rear door in the open orientation with the first hinge assembly installed to a recessed area and gutter area of the vehicle body structure in accordance with the first embodiment;

FIG. 10 is another perspective view of the rearward corner of the vehicle body structure looking from a different angle as compared to FIG. 9, with the rear door removed, showing details of the hinge assembly and the locking assembly in accordance with the first embodiment;

FIG. 11 an exploded perspective view of elements of the hinge assembly including a first support bracket, a second support bracket, a first arm and a second arm, an electric motor, and the locking assembly including an actuator, a lever plate, a cable, and a lever arm in accordance with the first embodiment;

FIG. 12 is a perspective view of the hinge assembly and the locking assembly removed from the vehicle, fully assembly except for the motor in accordance with the first embodiment;

FIG. 13 is another perspective view of the hinge assembly and the locking assembly removed from the vehicle, fully assembly with the motor installed to engage spline gear teeth of a gear fixed to the first arm in accordance with the first embodiment;

FIG. 14 is a top view of the first support bracket removed from the recessed area of the roof structure, showing the gear welded to the first arm, the gear and the first arm being pivotable relative to the first support bracket about an axis in accordance with the first embodiment;

FIG. 15 is a cross-section of the first support bracket, the first arm and the gear taken along the line 15-15 in FIG. 14, showing the various features of the gear in accordance with the first embodiment;

FIG. 16 is perspective cross-sectional view of the first support bracket, the first arm and the gear also taken along the line 15-15 in FIG. 14 in accordance with the first embodiment;

FIG. 17 is perspective cross-sectional view of a rear corner of the rear portion of a vehicle body structure showing engagement of a shaft of the electric motor with internal spline gear teeth of the gear that is welded to the first arm in accordance with the first embodiment;

FIG. 18 is an exploded view of the features of the hinge assembly and the electric motor showing the support bracket, the first arm, the gear and the electric motor aligned with one another in accordance with the first embodiment;

FIG. 19 is a perspective view of the rear panel assembly and the electric motor with a motor bracket of the electric motor attached via mechanical fasteners to an adjustment bracket of the rear panel assembly, the bracket having a pair of oversized slots that receive the mechanical fasteners allowing for lateral and angular position adjustments of the electric motor with respect to the gear in accordance with the first embodiment;

FIG. 20 is another perspective view of the electric motor and the adjustment bracket with portions of the rear panel assembly and the motor bracket removed showing three areas of the adjustment bracket in accordance with the first embodiment;

FIG. 21 is another perspective view of the electric motor and the motor bracket installed to the adjustment bracket with outboard lateral portions of the rear panel assembly being removed showing an outboard area of the adjustment bracket in accordance with the first embodiment;

FIG. 22 is another perspective view of the adjustment bracket and electric motor with portions of the rear panel assembly removed showing the electric motor in an uninstalled orientation (phantom lines) and moved toward the installed orientation (solid lines in accordance with the first embodiment;

FIG. 23 is a perspective view similar to FIG. 20 showing the electric motor and a modified adjustment bracket having two closed end slots in accordance with a second embodiment; and

FIG. 24 is a perspective view similar to FIG. 21 showing the electric motor and motor bracket with fasteners extending through openings in the motor bracket and then through respective ones of the closed end slots fixedly attaching the electric motor to the modified adjustment bracket in accordance with the second embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

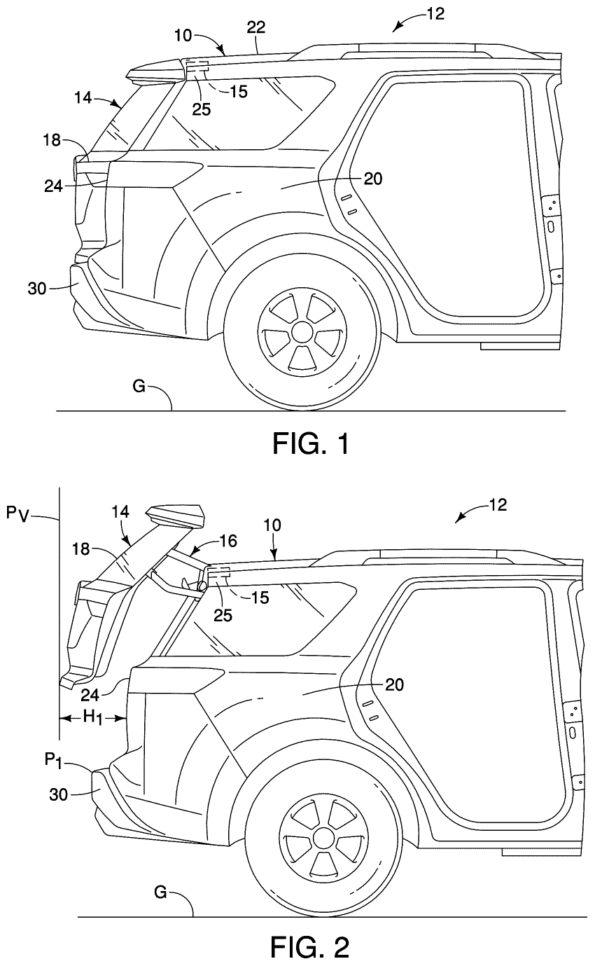

Referring initially to FIG. 1, a vehicle body structure 10 of a vehicle 12 having a rear door assembly 14 positioned by an electric motor 15 is illustrated in accordance with a first embodiment. In several of the drawings, a forward vehicle direction DF (also referred to as the forward direction DF) is shown along with a rearward vehicle direction DR (also referred to as the rearward direction DR), relative to the vehicle 12.

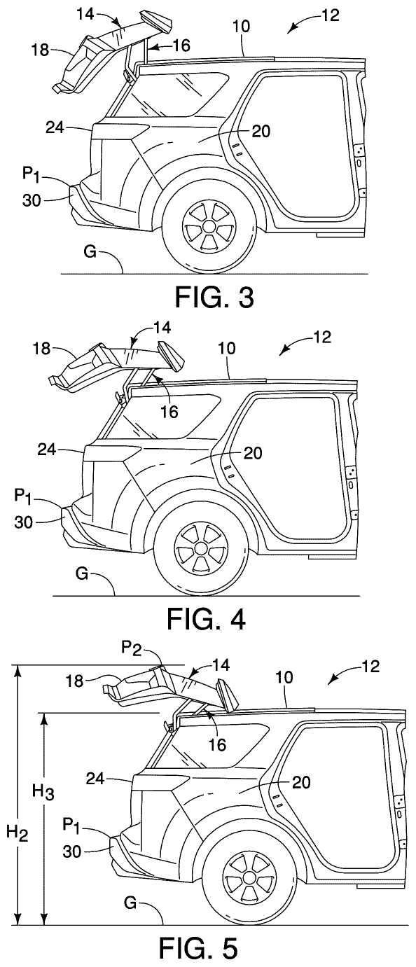

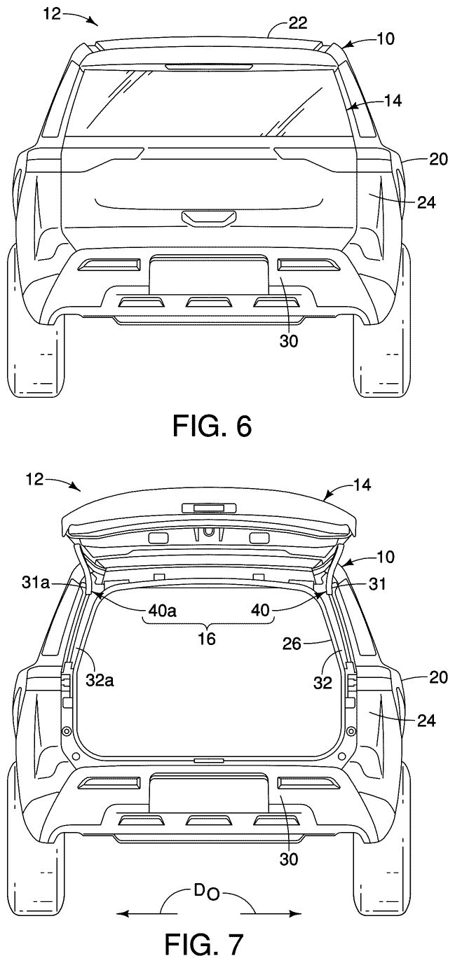

The rear door assembly 14 is attached to the vehicle body structure 10 by, for instance, a four-bar support mechanism 16 (also referred to as a pivoting bar mechanism 16 or a door linkage assembly 16) that also movably supports a rear door 18 to the vehicle body structure 10 when the electric motor 14 is operated, as is described in greater detail below. The four-bar support mechanism 16 is kinematically dimensioned and configured to move the rear door 18 of the vehicle 12 from a closed orientation shown in FIGS. 1 and 6 to various intermediate orientations shown in FIGS. 2-4 and eventually to a fully open orientation shown in FIGS. 5 and 7. It should be understood from the drawings and the description herein below that the four-bar support mechanism 16 can be replaced with other support mechanism configuration that do not include four bars, such as a two-bar mechanism that pivots about a single axis of rotation in order to support the rear door 18 for movement between a closed orientation and an open orientation.

The vehicle body structure 10 includes, among other features, side structures 20, a roof structure 22 and a rear structure 24 that are all rigidly connected to one another by, for example, various welding techniques. The rear structure 24 defines a rear door opening 26. Depending upon the overall design of the vehicle body structure 10, some or all of the side structures 20, the roof structure 22 and the rear structure 24 define a rear panel assembly 25 whose upper sides panels or upper side portions of various panels support the electric motor 15, as described in greater detail below.

When the rear door 18 is in the closed orientation, the rear door 18 covers the rear door opening 16, as shown in FIG. 6. When the rear door 18 is in the open orientation, the rear door opening 16 is fully exposed, as shown in FIG. 7.

As is described in greater detail below, the rear door assembly 14, and in particular, the four bar-support mechanism 16 of the rear door assembly 14, is configured such that the rear door 18 remains very close to the rear structure 24 and the roof structure 22 of the vehicle body structure 10 during movement of the rear door 18 between the closed orientation and the open orientation.

Specifically, when the rear door 18 is in a first intermediate orientation shown in FIG. 2, a lower end 18a of the rear door 18 moves a maximum distance H₁ away from the rear structure 24 with little or no further rearward displacement as the rear door 18 moves upward to an open orientation. More specifically, during the opening movement of the rear door 18, more than three quarters of the entire rear door 18 is located above and forward of a rearmost point P₁ from the fascia of a bumper assembly 33 relative to a vertical plane P_{V}, as shown in FIG. 2. In other words, only a very small percentage of the rear door 18 displaced rearward of the bumper assembly 33. This means that a person can be standing only a short distance away from the rear structure 24 of the vehicle 12 during opening and closing of the rear door 18.

The rear structure 24 further includes recessed areas 31 and 31a, as shown in FIG. 7. The recessed areas 31 and 31a are located on opposite sides of the rear structure 24 above and at least partially outboard of the rear door opening 26. Below each of the recessed areas 31 and 31a are gutters 32 and 32a that extend downward from respective ones of the recessed areas 31 and 31a alongside corresponding sides of the rear door opening 26.

Further, when the rear door 18 is in the fully open orientation, as shown in FIG. 5, a topmost part P₂ of the rear door 18 is at a height H₂ above ground level G. The roof structure 20 of the vehicle body structure 10 is located at a height H₃ above ground level G. The height H₃ is approximately 81% of the height H₂. In other words, the topmost part P₂ of the rear door 18 (at height H₂) is located less than 20% above the height of the roof structure 22 (the height H₃). This means that the rear door 18 can be opened in most typical garages where the ceiling height of the garage is greater than the height H₂.

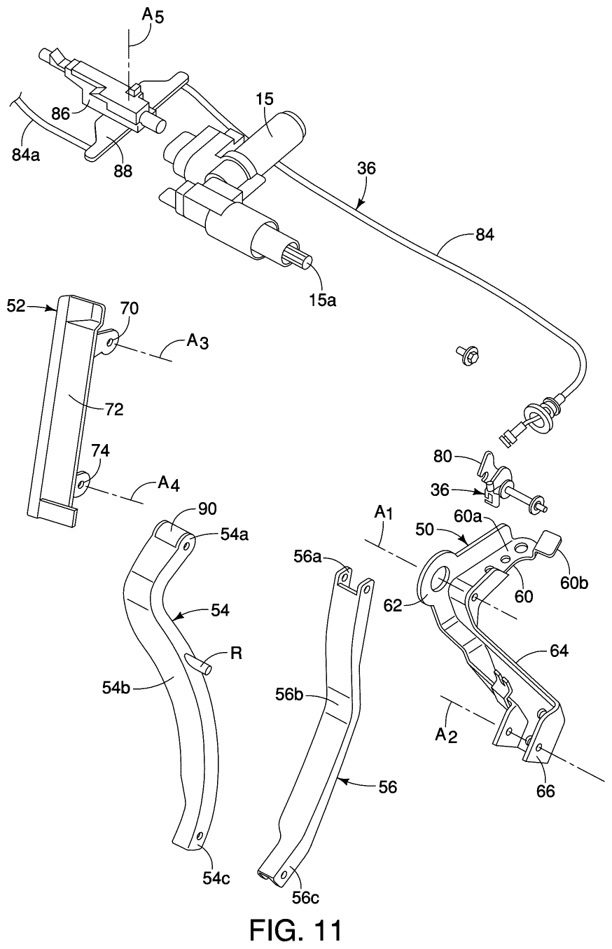

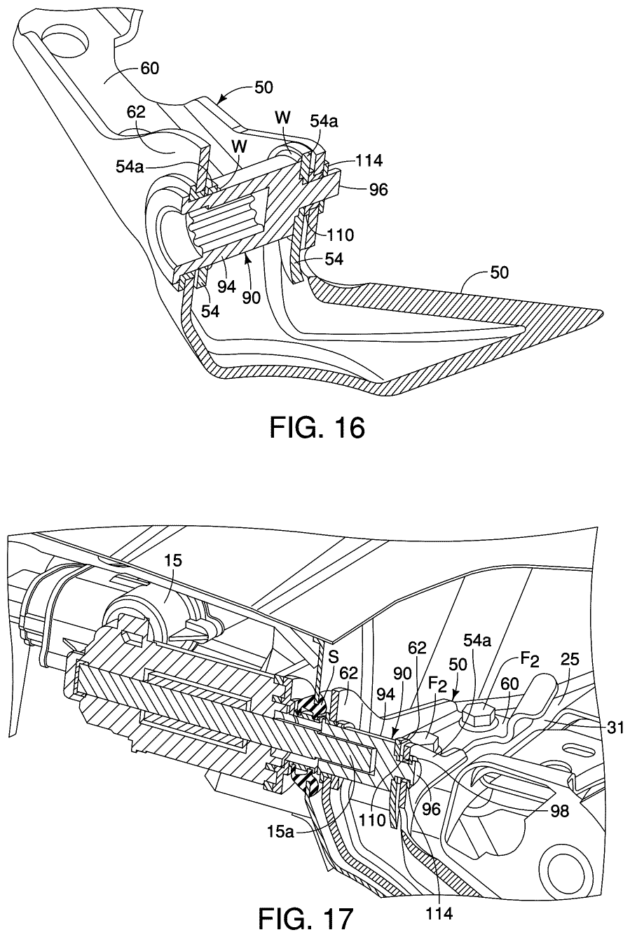

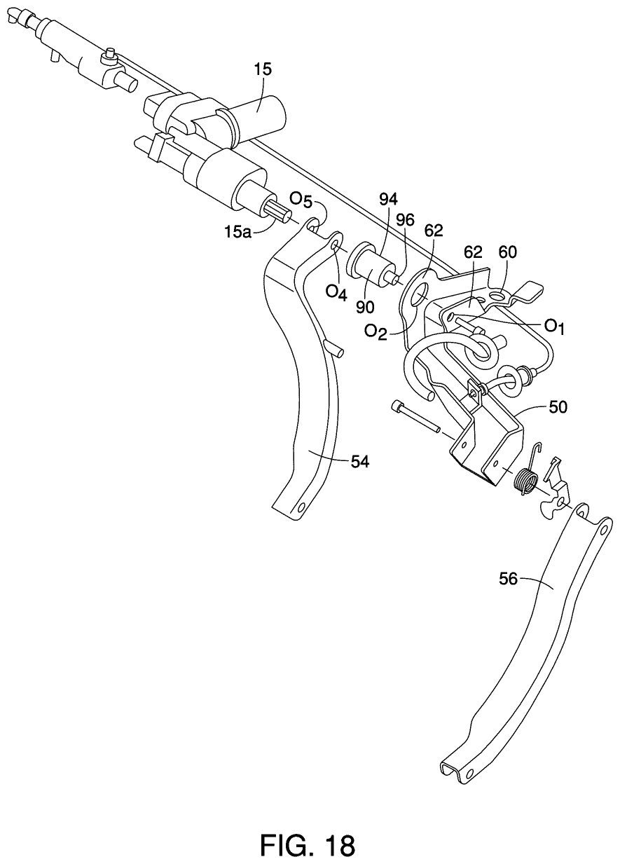

A description of the rear door assembly 14, the electric motor 15 and the four-bar support mechanism 16 is now provided with specific reference to FIGS. 7-19. The rear door assembly 14 includes the four-bar support mechanism 16, the electric motor 15 and a locking assembly 36.

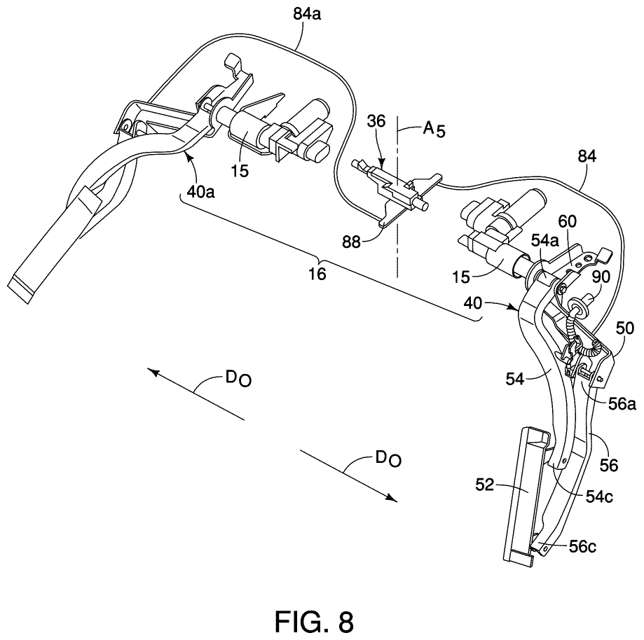

As shown in FIGS. 7-13, the four-bar support mechanism 16 includes two hinge assemblies 40 and 40a, as shown in FIGS. 7 and 8. The hinge assemblies 40 and 40a are basically identical to one another, except that they are symmetrical mirror images of one another. Therefore, in the description below, although the hinge assembly 40a will occasionally be referenced, the description below will focus on the hinge assembly 40, for the sake of brevity. It should be understood from the drawings and the description herein, that description of the hinge assembly 40 applies equally to the hinge assembly 40a. Further, there are two electric motors 15 located on opposite sides of the vehicle body structure 10 adjacent to opposites upper ends of the rear door opening 26. Description of one electric motor 15 applies equally to both electric motors 15.

Each of the hinge assemblies 40 and 40a have two pivoting bars, as described below. Hence, since there are four pivoting bars total in the hinge assemblies 40 and 40a, the two hinge assemblies 40 and 40a together, and associated elements, define the four-bar support mechanism 16. The four-bar support mechanism 16 is also described in co-pending U.S. patent application Ser. No. 18/520,476, filing date Nov. 27, 2023 and co-pending U.S. patent application Ser. No. 18/520,482, filing date Nov. 27, 2023. Both U.S. Ser. No. 18/520,476 and U.S. Ser. No. 18/520,482 are incorporated herein in their entirety.

As shown in FIG. 8, with the four-bar support mechanism 16 removed from the vehicle body structure 10, the four-bar support mechanism 16 is a stand alone assembly that can be installed to any vehicle that includes a rear door such as the rear door 18 and a rear door opening such as the rear door opening 26.

As shown in FIG. 8, the hinge assembly 40 (also referred to as a support structure 40) has a first support bracket 50 and a second support bracket 52, a first arm 54 and a second arm 56.

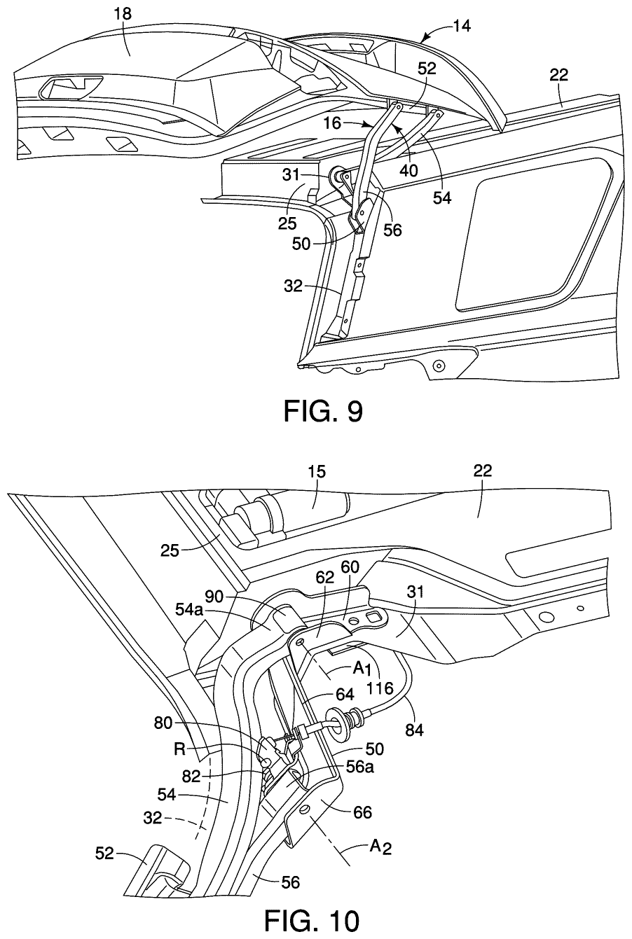

As shown in FIGS. 9-10, the first support bracket 50 is installed to the recessed area 31 and extends laterally in an outboard direction and downward into an upper area of the gutter 32 via mechanical fasteners. The first support bracket 50 is also referred to herein below as a pivoting lever 50.

As shown in FIGS. 10-13, the first support bracket 50 has a vehicle attachment portion 60, a first support portion 62, an intermediate section 64, and a second support portion 66 located outboard of the first support portion 62. The first support portion 60 is also located vertically higher than the second support portion 66 when installed to the vehicle 12. The vehicle attachment portion 60 of the first support bracket 50 includes a generally horizontally oriented section 60a and a stop bracket 60b. The generally horizontally oriented section 60a includes openings for mechanical fasteners that thread into corresponding threaded openings in the recessed area 31 for fixedly attaching the first support bracket 50 to the recessed area 31.

The intermediate section 64 of the first support bracket 50 extends in a vehicle outboard direction D_{O} from the generally horizontally oriented section 60a of the vehicle attachment portion 60.

The first support portion 62 is located at a rearward end of the generally horizontally oriented section 60a. The first support portion 62 includes two parallel flanges with openings whose centers define a first rotation axis A₁. The second support portion 66 extends downward from an outboard end of the intermediate section 64. The second support portion 66 includes two parallel flanges with openings whose centers define a second rotation axis A₂. The first rotation axis A₁ and the second rotation axis A₂ extend in directions that are parallel to one another. The first support bracket 50 is fixedly attached to the vehicle body structure 10 within the recessed area 31. The recessed area 31 is located adjacent to an upper end of the rear door opening 26. Specifically, a horizontally oriented section of the first support bracket 60 is attached to the recessed area 31 by mechanical fasteners (not shown). The second support portion 66 of the first support bracket 50 is attached to the gutter 32 via mechanical fasteners (not shown).

The second support bracket 52 has a third support portion 70, a rear door attachment portion 72 and a fourth support portion 74. The third support portion 70 and the fourth support portion 74 are spaced apart from one another with the rear door attachment portion 72 extending therebetween. The third support portion 70 includes at least one flange with an opening that defines a third rotation axis A₃. The fourth support portion 74 includes at least one flange with an opening that defines a fourth rotation axis A₄. The third rotation axis A₃ and the fourth rotation axis A₄ extend in directions that are parallel to one another. Further, the first rotation axis A₁, the second rotation axis A₂, the third rotation axis A₃ and the fourth rotation axis A₄ all extend in directions that are parallel to one another.

The first arm 54 has a first end 54a, an intermediate section 54b and a second end 54c. The intermediate section is located between the first end 54a and the second end 54c of the first arm 54. The intermediate section 54b curves in an outboard direction from the first end 54a and downward to the second end 54c of the first arm 54 with the rear door 18 in the closed orientation. In other words, the first arm 54 is not straight but curves in an outboard direction. The intermediate section 54b includes a lock engagement structure R (hereinafter referred to as a rod R or lock rod R). The rod R is preferably a cylindrically shaped rod that is welded or otherwise rigidly fixed to the first arm 54 and extends in an outboard direction from the first arm 54 in a manner described further below.

The first end 54a is attached to the first support portion 62 of the first support bracket 50 for pivotal movement about the first rotation axis A₁ defined by the first support portion 62 of the first support bracket 50. The second end 54c is attached to the third support portion 70 of the second support bracket 52 for pivotal movement about the third rotation axis A₃ defined by the third support portion 70 of the second support bracket 52.

The second arm 56 has a third end 56a, an intermediate section 56b and a fourth end 56c. The third end 56a is attached to the second support portion 66 of the first support bracket 50 for pivotal movement about a second rotation axis A₂ defined by the second support portion 66. The first rotation axis A₁ and the second rotation axis A₂ extend in directions parallel to one another. The second arm 56 has an intermediate section 56b between the third end 56a and the fourth end 56c of the second arm. The intermediate section extends downward from the third end 56a of the second arm 56. The intermediate section 56b further has a curved section that extends in a rearward direction to the second end 56c of the second arm 56 with the rear door 18 in the closed orientation.

The second end 54c of the first arm 54 is attached to the third support portion 70 of the second support bracket 52 for pivotal movement about a third rotation axis A₃ defined by the third support portion 70. The fourth end 56c of the second arm 56 is attached to the fourth support portion 74 for pivotal movement about a fourth rotation axis A₄.

The rear door attachment portion 72 of the second support bracket 52 includes a flat section that extends between the third support portion 70 and the fourth support portion 72 of the second support bracket 52. The rear door attachment portion 72 is attached to the lateral side of the rear door 18 via mechanical fasteners (not shown).

The stop bracket 60b of the first support bracket 50 is positioned and oriented to stop or limit movement the first arm 54 once the rear door 18 has moved toward the open orientation. Further, the stop bracket 60b further provides a place for the first arm 54 (and the rear door 18) to rest when the rear door 18 is in the open orientation.

As shown in FIGS. 8, 10-16, 18 and 23-27, the electric motor 15 is installed to a side rear area of the roof structure 22 such that a shaft 15a of the motor extends through an opening in the roof structure into the recessed area 31 and into a gear fixed within the first end 54a of the first arm 54 of the four-bar support mechanism 16. Specifically, see the cross-section in FIG. 25.

The rotary shaft 15a of the electric motor 15 has outer splines or gear teeth that define a gear fixed to the rotary shaft 15a. The gear of the rotary shaft 15a is inserted into the first end 54a of the first arm 54. The first end 54a has inner gear teeth defining a gear that meshed with and therefore rotates with the moto 34. Operation of the motor 15 moves or pivots the first arm 54 about the first rotation axis A₁ and further causing corresponding pivoting motion of the second arm 56 and the second support bracket 52 due to the pivoting configuration of the ends of the second arm 54 about the pivot axes A₂ and A₄.

More specifically, rotation of the shaft 15a of the motor 15 causes pivotal movement of the arms 54 and 56 which in turn causes movement of the rear door 18 between the closed orientation and the closed orientation.

When the operation of the motor 15 pivots the rear door 18 to the open orientation, the rear door opening 26 is fully exposed. When the operation of the motor 15 pivots the rear door 18 to the closed orientation, the rear door opening 26 is fully covered. In the closed orientation the rear door 18 is in a vertical orientation and in the open orientation the rear door 18 is in a horizontal orientation with at least half of the rear door 18 being located above the roof structure 24 of the vehicle body structure 10.

The four-bar support mechanism 16 is configured such that the first support portion 62 is located inboard of the second support portion 66 of the first support bracket 50. Put another way, the second support portion 66 of the first support bracket 50 is located outboard of the first support portion 62 of the first support bracket 50. Further, the first support portion 62 is located vertically higher than the second support portion 66 of the first support bracket 50 when installed to the vehicle body structure 10.

As shown in FIGS. 8 and 10-13, the locking assembly 36 (also referred to as the rear door lock assembly 36) includes a locking member 80 (also referred to as a lever arm 80), a biasing spring 82, cable 84 (and 84a), inner cable C, actuator 86, lever plate 88 and a lock rod R. The lever arm 80 is movable between a locked orientation and an unlocked orientation. More specifically, when the lock arm 80 is engaged with the lock rod R, the rear door 18 is locked in the closed orientation and cannot be opened.

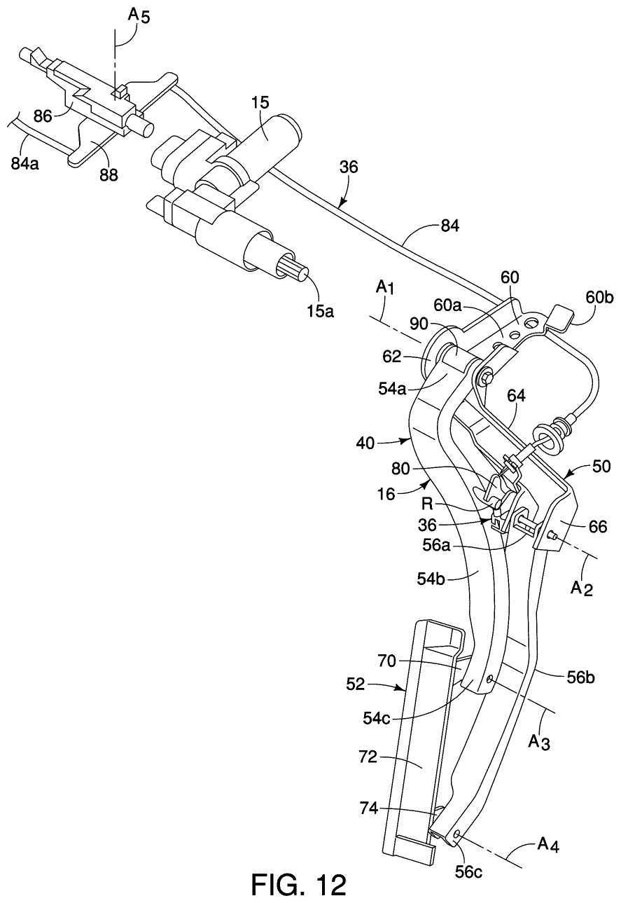

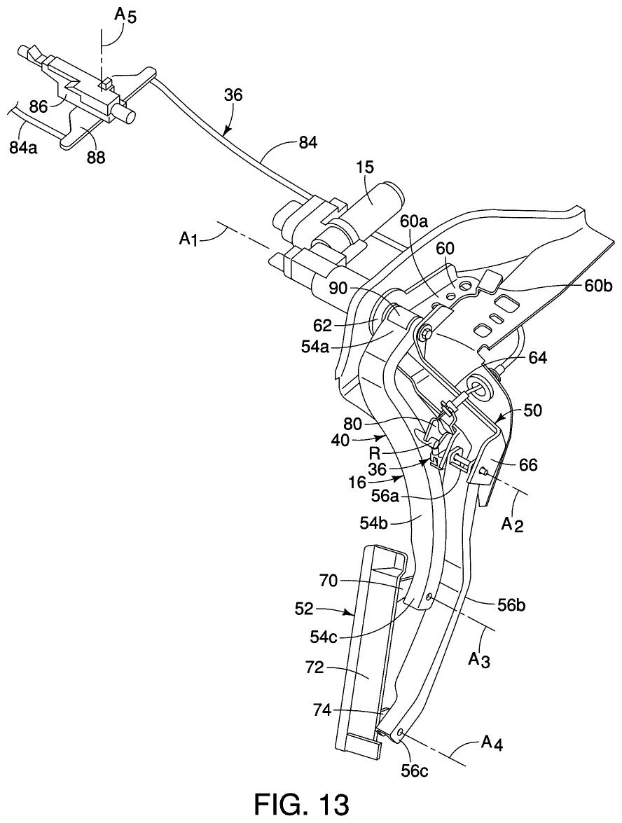

When the lock arm 80 is dis-engaged from the lock rod R (the unlocked orientation), the first arm 54 and all elements of the four-bar support mechanism 16 are free to move the rear door 18 from the closed orientation to the open orientation. As shown in FIGS. 12 and 13, the rod R extends in an outboard direction such that the lock arm 80 can engage and dis-engage from the rod R, as described below.

The lock arm 80 is attached to the inner cable C which is free to move in a lengthwise direction within the housing of the cable 84. The cable 84 can be, for example, a Bowden cable where a flexible hollow outer cable housing of the cable 84 allows linear movement of the inner cable C, with the inner cable C being capable of applying compressive and tensile forces thereby moving the lock arm 80. Since Bowden cables are conventional mechanical constructs, further description is omitted for the sake of brevity.

The lock arm 80 includes a recessed area 80a that is shaped to receive the lock rod R. Above the recessed area 80a is a tapered surface 80b that is contacted by the lock rod R when the rear door 18 is in the process of moving into the closed orientation. During such movement, the lock rod R contacts the tapered surface 80b pushing the lock arm 80 against the force of the biasing spring 82 (shown in FIG. 31) toward the unlocked orientation. The tapered surface 80b is basically a cam surface that responds to movement of the lock rod R as it contacts the cam surface.

Once the lock rod R is located within the recessed area 80a, the force of the biasing spring 82 urges the lock arm 80 into the locked orientation.

It should be understood from the drawings and the description herein that a second locking mechanism is located on the four-bar support mechanism 16 (the hinge assembly 40a in FIG. 8) at the opposite side of the vehicle body structure 10. The second locking mechanism also includes a lever arm that is controlled by a second cable 84a shown in FIG. 13.

The actuator 86 is preferably an electric motor or solenoid mechanism that is operated to rotate the lever plate 88 about the fifth axis A₅. The actuator 86 is fixed to a panel or panels (not shown) within the rearward portion of the roof structure 22. The actuator 86 includes a rotatable shaft (not shown) that defines a fifth axis of rotation A₅, as shown in FIGS. 12 and 13. The shaft of the actuator 86 is fixed to a lever plate 88 that pivots about the fifth axis of rotation A₅ when the actuator 86 is operated.

It should be understood from the drawings and the description herein that the two parts of a conventional locking mechanism can be installed to the bottom of the rear door 18 and at the center of the bottom of the rear door opening (above the bumper assembly 33), as shown in FIG. 7.

The actuator 86 and the electric motor 15 can be connected to an electronic controller (not shown) that is programmed to operate each of the actuator 86 and the electric motor 15 for the purpose of locking and unlocking the rear door 18 and opening and closing the rear door 18 upon receiving commands to do so from either a vehicle operator or a vehicle passenger.

The electronic controller preferably includes a microcomputer with a control program that controls the actuator 86 and the electric motor 34. The controller can also include other conventional components such as an input interface circuit, an output interface circuit, and storage devices such as a ROM (Read Only Memory) device and a RAM (Random Access Memory) device. The microcomputer of the controller is programmed to control the actuator 86 and the electric motor 34. The memory circuit stores processing results and control programs such as ones for operations that are run by the processor circuit. The controller is operatively coupled to the actuator 86 and the electric motor 15 in a conventional manner. The controller is further connected to a switch or switches that can be operated by a vehicle operator or a vehicle passenger in order to lock and unlock, and, open or close the rear door 18.

For a more detailed description of the elements of the four-bar support mechanism 16 see co-pending U.S. patent application Ser. No. 18/520,476, filing date Nov. 27, 2023 and co-pending U.S. patent application Ser. No. 18/520,482, filing date Nov. 27, 2023, both of which are incorporated herein in their entirety.

As shown in FIGS. 8-10 and 17-22, the electric motor 15 is installed to a side rear area of the roof structure 22 such that a shaft 15a of the motor extends through an opening in the roof structure into the recessed area 31 and into a gear 90 fixed within the first end 54a of the first arm 54 of the four-bar support mechanism 16. Specifically, see the cross-section in FIG. 10-18.

The rotary shaft 15a of the electric motor 15 has outer splines or gear teeth that define a gear at an end portion of the rotary shaft 15a. The rotary shaft 15a is inserted into the gear 90 which is fixed to the first end 54a of the first arm 54. The gear 90 at the first end 54a has inner splines or gear teeth that meshed with the splines on the rotary shaft 15a and therefore rotates with the motor 15. Operation of the motor 15 moves or pivots the first arm 54 about the first rotation axis A₁ and further causing corresponding pivoting motion of the second arm 56 and the second support bracket 52 due to the pivoting configuration of the ends of the second arm 54 about the pivot axes A₂ and A₄.

More specifically, rotation of the shaft 15a of the motor 15 causes pivotal movement of the arms 54 and 56 which in turn causes movement of the rear door 18 between the closed orientation and the closed orientation.

When the operation of the motor 15 pivots the rear door 18 to the open orientation, the rear door opening 26 is fully exposed. When the operation of the motor 15 pivots the rear door 18 to the closed orientation, the rear door opening 26 is fully covered. In the closed orientation the rear door 18 is in a vertical orientation and in the open orientation the rear door 18 is in a horizontal orientation with at least half of the rear door 18 being located above the roof structure 24 of the vehicle body structure 10.

The four-bar support mechanism 16 is configured such that the first support portion 62 is located inboard of the second support portion 66 of the first support bracket 50. Put another way, the second support portion 66 of the first support bracket 50 is located outboard of the first support portion 62 of the first support bracket 50. Further, the first support portion 62 is located vertically higher than the second support portion 66 of the first support bracket 50 when installed to the vehicle body structure 10.

As shown in FIGS. 8 and 10-13, the locking assembly 36 (also referred to as the rear door lock assembly 36) includes a locking member 80 (also referred to as a lever arm 80), a biasing spring 82, cable 84 (and 84a), inner cable C, actuator 86, lever plate 88 and a lock rod R.

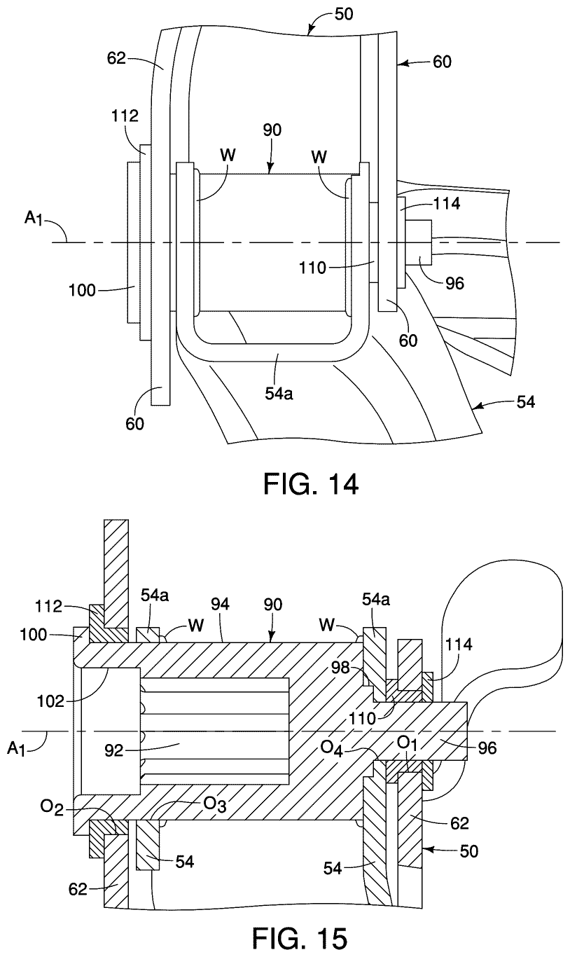

A description of the gear 90 is now provided with specific reference to FIGS. 14-18. As shown in FIGS. 14 and 15, the gear 90 includes the following portions and features: a semi-hollow interior with spline gears 92 (also referred to as splines), a main cylindrical portion 94, a swage pin 96, an annular protrusion 98 surrounding the swage pin 96, an annular flange 100, and an annular recessed area 102 adjacent to the spline gears 92 within the semi-hollow interior of the gear 90. The gear 90 is installed to the first end 54a of the first arm 54 of the support assembly 16 and the first support potion 62 of the first support bracket 50 by a first bushing 110, a second bushing 112 and a washer 114.

The installation of the gear 90 to the support assembly 16 is apparent in FIG. 15. First, the first bushing 110 (right side of FIG. 15) is inserted into an opening O₁ in the outboard one of the first support portions 62 of the first support bracket 50. Further, the second bushing 112 (left side of FIG. 15) is inserted into an opening O₂ in the inboard one of the first support portions 62 of the first support bracket 50.

As is further shown in FIG. 15, thereafter, the gear 90 is inserted through the open center of the second bushing 112 and hence through the opening O₂ in the inboard one of the first support portions 62 of the first support bracket 50. The gear 90 then passes through an opening O₃ in the outboard one of the first ends 54a of the first arm 54. Thereafter, the gear 90 passes through an opening O₄ in the outboard one of the first arms 54 and then the swage pin 96 extends through the first bushing 110 and hence, the opening O₁ in the outboard one of the first support portions 62 and the washer 114.

Once the gear 90 is installed to the first support bracket 50 and the first arm 54, the swage pin 96 can be deformed or swaged, thereby shortening and enlarging the outer circumferential surface of the swage pin 96. Once the swage pin 96 is swaged to form the annular protrusion 98 (deformed portion of the swage pin 96), as shown in FIG. 17. The swaged swage pin 96 and the annular flange 100 retain the gear 90 to the first support bracket 50. The swaged swage pin 96 is swaged against the washer 114. Further, the main cylindrical portion 94 of the gear 90 is welded via annular welds W to the first ends 54a of the first arm 54. The gear 90 has an outer cylindrical-like portion 94 that has generally smooth appearing outer surface. However, the outer surface of the outer cylindrical-like portion 94 is preferably not completely polished and can have a rough surface sections at either end thereof for purposes of welding to the first end 54a of the first arm 54, as described below.

The gear 90 is fixedly attached to the first arm 54 via any of a variety of welding techniques to the gear 90 (and by the swaged swage pin 96 (FIG. 17) such that the first arm 54 and the gear 90 pivot as one unit or single element about the axis A₁ relative to the first support bracket 50. The gear 90 can pivot relative to the first support bracket 50 since the gear 90 is supported by the first and second bushings 110 and 112.

A description of the rear panel assembly 25 and the motor 15 is now provided with reference to FIGS. 17-22.

The rear panel assembly 25 includes a plurality of panels that intersect and/or overlap one another at the rear end of the vehicle 12. These panels can include corresponding portions of a rear pillar structure, the side structure 20, the roof structure 22 and the rear structure 24. As described above, the vehicle attachment portion 60 of the first support bracket 50 is secured to panels that define the recessed area 31 via fasteners F₂.

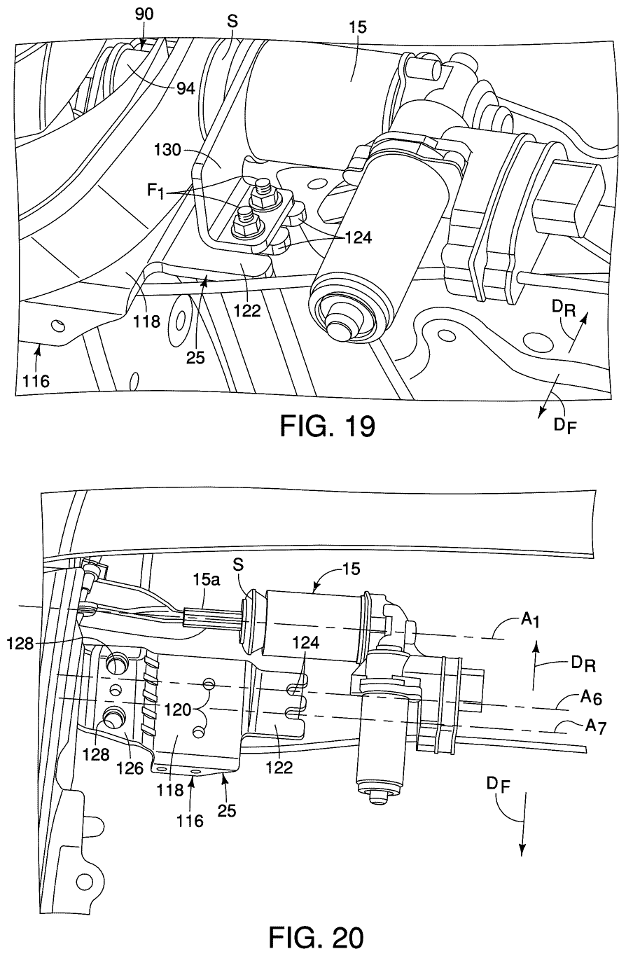

Portions of the roof panel structure 22 are removed in FIGS. 19-22 revealing an adjustment bracket 116 and the electric motor 15. The adjustment bracket 116 is part of the rear attachment structure 25 and includes three different sections. The three different sections of the adjustment bracket 116 include a hinge attachment portion 118 with openings 120, a motor attachment portion 122 with slots 124 and a body attachment portion 126 with openings 128.

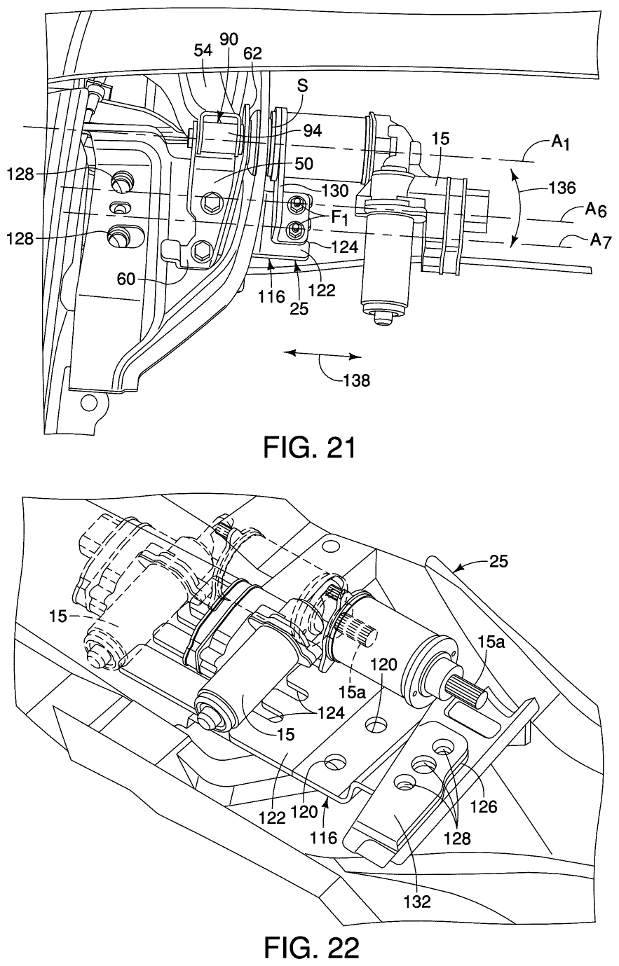

As shown in FIGS. 20 and 21, each of the pair of slots 124 define respective central axes A₆ and A₇ extending therethrough in a lengthwise direction of the slots 124. The axis A₆ and axis A₇ are preferably parallel to one another and parallel or approximately parallel to the axis A₁ of the gear 90.

The openings 120 in the hinge attachment portion 118 align with the panels that define the recessed areas 31 and the openings in the vehicle attachment portion 60 of the first support bracket 50 such that the fasteners F₂ threadedly attach thereto, securing the first support bracket 50 to the alignment bracket 116.

The openings 128 of the body attachment portion 126 of the alignment bracket 116 align with various panels of, for example, the side structure 20, the roof structure 22 and the rear structure 24. The body attachment portion 126 of the alignment bracket 116 includes fasteners (not shown) that fixedly attach the alignment bracket 116 to the various panels of, the side structure 20, the roof structure 22 and the rear structure 24.

Consequently, the adjustment bracket 50 is rigidly and fixedly attached to the vehicle body structure 10 before the electric motor 25 is installed to the motor attachment portion 122 of the alignment bracket 116. In FIG. 22, a spacer/reinforcing plate 132 is shown overlaying the body attachment portion 126 of the alignment bracket 116. However, the openings 128 are visible through aligning openings in the spacer/reinforcing plate 132. Since the slots 124 (the axis A₆ and axis A₇) are parallel to one another and parallel or approximately parallel to the axis A₁ of the gear 90, proper alignment between the shaft 15a of the electric motor 15 and the spline gears 92 of the gear 90 is easier to achieve.

As shown in FIGS. 19 and 21, the electric motor 15 includes a motor bracket 130 that extends perpendicularly away from the shaft 15a of the motor 15 in a vehicle forward direction DF and includes an attachment portion with openings that receive mechanical fasteners F₁. The fasteners F₁ further extend into the slots 124 of the motor attachment portion 122 of the alignment bracket 116. The motor bracket 130 (also referred to as a mechanical attachment portion 130) is removed in other figures in order to show the various details of the depicted structures around the motor 15.

The width of each of the slots 124 is oversized as compared to the fasteners F₁ to allow positioning of the motor 15 relative to the spine gears 92 of the gear 90 in motor adjustment directions, such as angular movement 136 and linear movement 138, as shown in FIG. 21. As shown in FIG. 22, during initial installation of the motor 15, the motor 15 is moved linearly from an uninstalled orientation (phantom lines) toward an installed orientation (solid lines).

As shown in FIG. 21, the motor 15 can undergo linear movement 138 and angular movement 136 in order to insert the shaft 15a of the motor 15 into the gear 90 and aligning the shaft 15a with the spline gears 92 within the hollow interior (the bore) of the gear 90.

Once the motor 15 is aligned with the gear 90, the threaded mechanical fasteners F₁ extending through corresponding ones of the plurality of parallel slots 124 can be tightened to a pre-determined torque, thereby fixedly attaching the motor 15 to the adjustment bracket 116. Thereafter, operation of the electric motor 15 can move the rear door 14 between the open orientation and the closed orientation.

In other words, the fasteners F₁ and the slots 124 define mechanical attachment portions that adjustably align with the motor attachment section 122 with the motor 15 such that the position and orientation of the shaft relative to the spline gears 92 of the gear 90 can be adjusted. Hence, alignment between the shaft 15a and the bore or hollow interior of the gear 90 can be easily achieved with the motor 14 thereafter being rigidly fixed in position to the motor attachment section 122 of the adjustment bracket 116.

### Second Embodiment

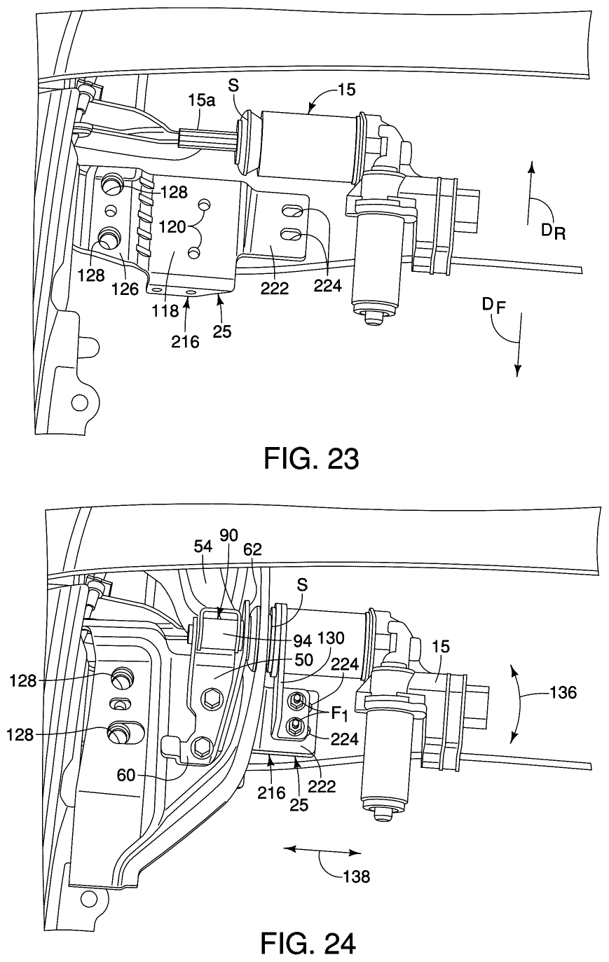

Referring now to FIGS. 23 and 24, an adjustment bracket 216 of the vehicle body structure 10 in accordance with a second embodiment will now be explained. The adjustment bracket 216 replaces the adjustment bracket 116 of the first embodiment. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

The adjustment bracket 216 includes the hinge attachment portion 118 with the openings 120 and the body attachment portion 126 with openings 128. However, the motor attachment portion 122 of the first embodiment has been modified to define a motor attachment portion 222 with a plurality of parallel slots 224 (two slots 224) that have closed ends. Similar to the first embodiment, in the second embodiment the fasteners F₁ have a threaded portion with a diameter that is less than the width of the slots 224 such that the motor 15 can undergo linear movement 138 and angular movement 136 in order to properly align the shaft 15a with the spline gears 92 within the hollow interior (the bore) of the gear 90.

The various vehicle body structures, other than those features specifically described above, are conventional components that are well known in the art. Since these body structures are well known in the art, these structures will not be discussed or illustrated in detail herein. Rather, it will be apparent to those skilled in the art from this disclosure that the components can be any type of structure and/or programming that can be used to carry out the present invention.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “forward”, “rearward”, “above”, “downward”, “vertical”, “horizontal”, “below” and “transverse” as well as any other similar directional terms refer to those directions of a vehicle equipped with the vehicle rear door structure. Accordingly, these terms, as utilized to describe the present invention should be interpreted relative to a vehicle equipped with the vehicle rear door structure.

The term “configured” as used herein to describe a component, section or part of a device that is constructed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle rear door structure, comprising:
a vehicle body structure having a rear panel assembly that defines a rear opening and a motor attachment section;
a door linkage assembly connected to the rear panel assembly adjacent to one side of the rear opening, the door linkage assembly including at least one pivoting lever with a first end having a bore with an inner splined surface;
a rear door attached to the rear panel assembly via the door linkage assembly for movement between an open orientation exposing the rear opening and a closed orientation covering the rear opening; and
an electric motor having a mechanical attachment portion and a shaft having outer splines dimensioned and shaped to fit within the bore and engage the inner splined surface such that operation of the electric motor moves the rear door between the open orientation and the closed orientation, the mechanical attachment portion having a plurality of attachment structures that adjustably align with the motor attachment section such that the position and orientation of the shaft can be adjusted into alignment with the bore and thereafter are rigidly fixed in position to the motor attachment section.

2. The vehicle rear door structure in accordance with claim 1, wherein
the motor attachment section of the rear panel assembly includes a plurality of parallel slots, each of the parallel slots having a first width, and
the plurality of attachment structures of the mechanical attachment portion of the electric motor includes a plurality of threaded mechanical fasteners, each threaded mechanical fastener having a threaded portion having an outer diameter that is less than the first width of each of the parallel slots.

3. The vehicle rear door structure in accordance with claim 2, wherein
each of the plurality of parallel slots has one open end.

4. The vehicle rear door structure in accordance with claim 2, wherein
each of the plurality of parallel slots has closed ends.

5. The vehicle rear door structure in accordance with claim 2, wherein
the electric motor is fixedly attached to the motor attachment section of the rear panel assembly when the threaded mechanical fasteners extend through corresponding ones of the plurality of parallel slots and are tightened to a pre-determined torque.

6. The vehicle rear door structure in accordance with claim 1, wherein
the pivoting lever of the door linkage assembly is part of a four-bar support mechanism that supports the rear door to the rear panel assembly.

7. The vehicle rear door structure in accordance with claim 1, wherein
the at least one lever includes a metal sleeve welded to the first end thereof, the hardened metal sleeve having the bore with the inner splined surface.

8. The vehicle rear door structure in accordance with claim 7, wherein
the motor attachment section of the rear panel assembly includes a plurality of parallel slots, each of the parallel slots having a first width, and
the plurality of attachment structures of the mechanical attachment portion of the electric motor includes a plurality of threaded mechanical fasteners, each threaded mechanical fastener having a threaded portion having an outer diameter that is less than the first width of each of the parallel slots.

9. The vehicle rear door structure in accordance with claim 8, wherein
each of the plurality of parallel slots has one open end.

10. The vehicle rear door structure in accordance with claim 8, wherein
each of the plurality of parallel slots has closed ends.

11. The vehicle rear door structure in accordance with claim 8, wherein
the electric motor is fixedly attached to the motor attachment section of the rear panel assembly when the threaded mechanical fasteners extend through corresponding ones of the plurality of parallel slots and are tightened to a pre-determined torque.

12. The vehicle rear door structure in accordance with claim 8, wherein
the pivoting lever of the door linkage assembly is part of a four-bar support mechanism that supports the rear door to the rear panel assembly.

13. The vehicle rear door structure in accordance with claim 1, wherein
the door linkage assembly includes a support bracket having a vehicle attachment portion and a first support portion, the at least one pivoting lever being pivotally supported to the first support portion of the support bracket, and
the rear panel assembly includes a bracket that defines the motor attachment section and a support bracket attachment section, the electric motor being attached to the motor attachment section and the support bracket attachment section being attached to the vehicle attachment portion of the support bracket.

14. The vehicle rear door structure in accordance with claim 13, wherein
the motor attachment section of the bracket includes a plurality of parallel slots, each of the parallel slots having a first width, and
the plurality of attachment structures of the mechanical attachment portion of the electric motor includes a plurality of threaded mechanical fasteners, each threaded mechanical fastener having a threaded portion having an outer diameter that is less than the first width of each of the parallel slots.

15. The vehicle rear door structure in accordance with claim 14, wherein each of the plurality of parallel slots has one open end.

16. The vehicle rear door structure in accordance with claim 14, wherein
each of the plurality of parallel slots has closed ends.
